(19) United States
(12) Patent Application Publication
(10) Pub. No.: US 2024/0001701 A1
(43) Pub. Date: Jan. 4, 2024

(54) A METHOD FOR MANUFACTURING A DÉCOR PAPER OR FOIL AND A DÉCOR PAPER OR FOIL

(71) Applicants: Flooring Industries Limited, SARL, Bertrange (LU); Interprint GmbH, Arnsberg (DE)

(72) Inventors: Benjamin CLEMENT, Waregem (BE); Michiel BLIEK, Gent (BE)

(73) Assignees: Flooring Industries Limited, SARL, Bertrange (LU); Interprint GmbH, Arnsberg (DE)

(21) Appl. No.: 18/255,276

(22) PCT Filed: Dec. 15, 2021
(86) PCT No.: PCT/IB2021/061737

§ 371 Date: May 31, 2023

(30) Foreign Application Priority Data
Dec. 24, 2020 (EP) 20217184.9

(51) Int. Cl. B41M 3/00; B41M 1/28; B41M 1/18; B41M 5/00

(52) U.S. Cl. CPC B41M 3/008; B41M 1/28; B41M 1/18; B41M 5/0017

(57) ABSTRACT

A method for manufacturing a décor paper or foil may involve providing a paper layer or a foil. The paper layer or the foil may be provided with a first printed motif that is provided by a first printing technique. A second printed motif may be provided above the first printed motif. The second printed motif may be provided by a second printing technique. The paper layer or the foil may be provided with an ink receiver layer.

This application claims priority under 35 USC § 119(a)-(d) to EP patent application No. 20217184.9, which was filed on Dec. 24, 2020, the entire content of which is incorporated herein by reference.

### BACKGROUND

### 1. Field

The present invention relates to a method for manufacturing a décor paper or a décor foil, for example for forming decorative layer of panels or boards, preferably floor, wall or ceiling panels or furniture panels. The invention further relates to a décor paper or a décor foil. In addition, the invention relates to panels having a décor paper or foil and method for manufacturing panels having a décor paper or foil.

### 2. Related Art

Decorative papers for laminate boards are normally printed by rotogravure or other analog printing technologies. Rotogravure printing is widely used because provides high production rate at a relatively low cost, thanks also to the use of relatively cheap inks. On the other hand, rotogravure requires the preliminary operation of engraving rollers dedicated to the print of one specific décor. This preliminary operation is expensive and time consuming so that make small production batch uneconomic.

Decorative papers for laminate boards can also be printed by inkjet printing. Inkjet printing is a more flexible technology compared to rotogravure and permits the production of small and customizable badges. Inkjet printing further provides for more complex and variable décors. On the other hand, inkjet printing has normally a lower production rate compared to rotogravure and require relatively expensive inks.

### SUMMARY

The present invention aims in the first place to provide an alternative solution, which, in accordance with several of its preferred embodiments, is directed to solve one or more of the problems arising in the state of the art.

Thereto, the present invention, according to its first independent aspect, the invention relates to a method for manufacturing a décor paper or foil that comprises the step of providing a paper layer or a foil, for example a thermoplastic foil, providing said paper layer or foil with a first printed motif, wherein said first printed motif is provided by means of a first printing technique, the method further comprises the step of providing said paper layer or foil with a second printed motif, wherein said second printed motif is provided by means of a second printing technique, and wherein the method comprises the step of providing said paper or foil with an ink receiving layer. Preferably, said first and second printed motifs and the ink receiver layer are provided on a same surface of the paper or foil. By combining multiple printed motifs, it is possible to overcome the drawbacks of printing only one motif and in particular it is possible to overcome the drawbacks of one printing technique by printing each printed motif with a specific techniques. Combining multiple printing motifs further provides the advantage of increasing the variability of printing décors, thanks to the enlarged possibilities of combinations of the two motifs. The ink receiving layer further provides the advantage of improving the ink absorption thereby minimizing the color variation caused by the combination of multiple printed motifs, thereby improving the quality of the décor paper or foil.

In the preferred embodiment, the first and the second printed motif can be both visible on the top surface of the paper. In fact, preferably, the décor paper can comprise a décor pattern that is formed by the combination of the first printed motif and the second printed motif.

In the preferred embodiment, the second printing step can be performed in line with the first printing step. The step of providing the paper or foil with the ink receiver layer can be performed in line with at least one between the first and the second printing step, preferably with both the printing steps.

Preferably, the second printed motif is printed on top of the first printed motif. In a preferred embodiment the first printed motif can represent a background for the second printed motif. For example, the first printed motif can comprise a solid color motif with a color configured to minimize the quantity of ink forming the second printed motif. The second printed motif be configured to provide detail above the first printed motif. For example, the first printed motif can comprise a basic wood imitating pattern and the second printed motif can comprise a wood or stone imitating pattern which add wood or stone nerves and pore details above the basic wood or stone pattern of the first printed motif in order to improve to variability of obtainable décors. In some embodiments, the second printed motif can be in register with the first printed motif. In practice, the second printed motif can comprise structural features corresponding to structural features of the first printed patter. For sake of example, in case of wood imitating printed motifs, the second printed motif can comprise wood nerves details printed adjacent to wood nerves in the basic wood pattern of the first printed pattern. In the most preferred embodiment, the first printing technique can be performed to provide a homogeneous distribution of pigments on an upper surface of said paper or foil.

In the preferred embodiment, the first printed motif is printed uniformly on the paper, preferably the décor paper or foil provided with the sole first printed motif shows an average color variation (ΔE) (Lab CIELAB) on the surface of the paper that is below 1, preferably below 0.5. In the preferred embodiment, the second printed motif is a more variable décor so that shows a higher color variation, preferably the décor paper or foil provided with the first and second printed motif shows an average color variation (ΔE) on the surface of the paper that is above 0.5, preferably above 1. In the preferred embodiment, the ink receiver layer is provided uniformly on the paper and is preferably transparent, preferably the décor paper or foil provided with the first printed motif and with the ink receiver layer shows an average color variation (ΔE) on the surface of the paper that is below 2, more below 1, even more preferably below 0.5. In particular, the ink receiver layer is sufficiently transparent so that in case the ink receiver layer is printed upon at least one between the first printed motif and the second printed motif, it causes a difference of color variation (ΔE) of the printed motif below, measured between before and after providing said ink receiver layer that is lower than 2, preferably lower than 1, more preferably lower than 0.5 measured on the same spot, for example measured on the average value of color variation (ΔE) on the surface of the paper or foil. Preferably, the ink receiver layer is sufficiently transparent to cause a difference of color variation (Lab CIELAB) of the printed motif below, measured between before and after providing said ink receiver layer that is lower than the 20%, preferably lower than the 15%.

In a preferred embodiment, said first printed motif is obtained by printing at least a first ink that penetrates the paper layer or foil for at least one tenth of the thickness of said paper or foil, preferably such that the paper of foil is fully colored by said first ink. For example, said first ink comprise a dye and/or a pigment and a wetting agent. Said wetting agent is configured to improve penetration of the first ink into the paper or foil. In this is way it is possible to color the paper or foil in such a way that it can be configured to minimize the quantity of ink forming the second printed motif and/or to enhance the second printed motif.

Although, it is possible that the printed motifs are printed with the same printing techniques, in the preferred embodiment of the invention the first and the second printing techniques are preferably different each other. This can provide the advantage of limiting the drawbacks of each printing technique. Preferably, said first and second printing technique comprise one analog printing technique and one digital printing technique. The use of analog printing technique can provide the effect of reducing the consumption of inkjet inks whereas the use of digital printing technique can improve the variability of the décors obtainable via the analogue printing technique. In the most preferred embodiment, the first printed motif is printed via an analogue technique and the second printed motif is printed via a digital printing technique above the first printed motif. For example, the analogue printed motif can form a background décor or a background color for the upper digitally printed décor. In this way, it is possible to reduce the quantity of digitally printed ink in view of an increase of the use of analog printed inks thereby reducing the cost of the printed paper or foil. In this way it is also possible to combine a digitally printed motif with an analog print that can comprise pigments non-printable with digital techniques in order to provide, for example, special effects. According to an alternative embodiment, it is possible that the first printed motif is printed via digital technique and the second printed motif is printed via an analogue printing technique above the first printed motif.

The analog printing technique can preferably be rotogravure, flexography, screen or offset printing. In a preferred embodiment of the invention, the analog printed motif can comprise at least one color substantially distributed on an upper surface of said paper or foil, preferably the printed motif is a solid color motif. In particular, the analog printing technique can be performed to provide a homogeneous distribution of pigments on an upper surface of said paper or foil. Said color of the analog printed motif is configured to minimize the quantity of digital ink provided thereupon, preferably said color of the analog printed motif comprises white, yellow, brown, beige or grey. By providing the upper surface of the paper or foil can also provide the advantage of fully covering the original color of the starting paper or foil. When digitally printing a non-colored paper, e.g. white paper, there are normally left blank areas at the edge of the paper or foil and/or between multiple digitally printed layers. By coloring the upper surface of the paper or foil with an analog printed base color it is possible to prevent forming of such blank areas.

Preferably, the analog printed pattern can comprise an average color variation (ΔE) on the surface of the paper that is below 1, preferably below 0.5. This is particularly the case wherein the analog printed pattern is used to print a solid background color. In this way it is possible to start from a standard printable paper and color it in a substantially uniform manner so to replicate the same result obtainable by using a pre-colored printable paper. Such low values of color variation (ΔE) represent a color variation that is not noticeable by human eye so that the printed motif can be considered perfectly uniform. Preferably, the analog printed motif can comprise a substantially the same quantity of pigment per surface unit above the entire surface of the paper or foil, said quantity of dry pigment per surface unit can be below 20 g/sqm, preferably below 10 g/sqm.

In other embodiments the analog printed motif can also comprise a wood or stone imitating motif. According to some embodiments of the invention, the analog printed motif can comprise metallic, pearlescent, and/or white pigments. The analog printed motif can also be printed by means of inks comprising combinations of multiple inks, so that it is possible to create specific spot colors thereby broaden up the color gamut. Said pigments are normally not printable with digital printing techniques, therefore thanks to this solution it is possible to combine the use of said pigments with a digitally printed motif. For example, said pigments can have a particle size above 1 μm and/or below 100 μm.

Preferably the digital printing technique can be inkjet printing. Preferably for printing the digital printed motif, a digital inkjet printer is applied that allows to jet ink droplets with a volume of less than 50 picoliters. The inventors have found that working with droplets having a volume of 15 picoliters or less, for example of 10 picoliters, brings considerable advantages regarding the limitation of dry weight of deposited inks. Preferably a digital inkjet printer is applied that allows to work with ink droplets of several volumes in one and the same print, or with so-called halftone or gray scale. The possibility of half tone or gray scale printing enables further limitation of the dry weight of deposited ink while maintaining an excellent print definition. Preferably a digital inkjet printer is applied that allows to attain a definition of at least 200 dpi, or even better at least 300 dpi (dots per inch), even more preferably at least 600 dpi. Preferably said digital inkjet printer is of the single pass type, wherein the paper layer or foil is provided with said printed pattern in a single continuous relative movement of the paper layer with respect to the printer or print heads. It is not excluded that other digital inkjet printers are used to put the invention into practice, such as so-called multi-pass or plotter type printers. It is noted that printers of the multi-pass type have the advantage that any failing nozzle can be hidden by the print of a subsequent pass. In this type of printers, the nozzles or paper can be shifted somewhat in between passes, such that on a particular location of the paper dots are printed by several nozzles. With a multi-pass equipment, or even with a plotter it is possible to perform automatic maintenance or cleaning in between subsequent passes, when needed.

Preferably, the digitally printed motif can be printed with pigment containing inks. The digitally printed motif can be printed with solvent-based, UV-curable or, preferably, water-based. It is also possible to use a combination of these inks, like for example UV-curable water-based inks. Said digital printing can be performed by printing an amount of ink below 20 g/sqm. Said digital printing can also be performed by providing said paper or foil with an amount of pigments below 10 g/sqm, preferably below 7 g/sqm. Preferably the digitally printed motif can comprise a décor that can be a wood imitating or stone imitating décor or any other desired pattern or drawing. In case the digitally printed décor is the second printed motif it can be printed in register with the first printed motif. Preferably, the digitally printed pattern can comprise an average color variation (ΔE) on the surface of the paper that is above 0.5, preferably above 1. The décor paper or foil provided with the digital printed motif shows an average color variation (ΔE) on the surface of the paper that is above 0.5, preferably above 1.

In some embodiments of the invention, the digitally printed motif and/or the analog printed motif can comprise functional pigments like for examples photosensitive pigments, thermosensitive pigments, pressure sensitive pigments. Said functional pigments are pigments configured to provide a response to an external solicitation like for example a change of color in response to a change of temperature, irradiation with a specific radiation or pressure applied on the motif.

The ink receiver layer is provided below at least one of the printed motifs, preferably below any digital printed motif. In fact, the ink receiver layer can improve the quality of the digital print for example by improving ink absorbency of the paper or foil, in particular by reducing ink bleeding and controlling the dotgain. The ink receiver layer can further provide for improved dot gain and color gamut. In the preferred embodiment the ink receiver layer is provided between the first and the second printed motif. In this preferred embodiment, the ink receiver layer is preferably transparent or translucent.

In case the ink receiving layer is printed on top of a printed motif, the ink receiver layer can be sufficiently transparent to not affect the color stability of the printed motif below. For example the combination of the printed motif and the ink receiver layer there upon can have a color variation (ΔE) with a maximum value of 2, preferably with a maximum value of 1, more preferably with a maximum value of 0.5 measured on the same spot before and after applying the ink receiving layer. Preferably, the ink receiver layer is sufficiently transparent to cause a difference of color variation (Lab CIELAB) of the printed motif below, measured between before and after providing said ink receiver layer that is lower than the 20%, preferably lower than the 15%. Such low difference of color variation is not noticeable by human eye so that the ink receiver layer doesn't affect the color of the below provided first printed motif.

In a preferred embodiment the ink receiver layer is provided through analog coating or printing techniques, like rotogravure or flexographic print. Preferably, the ink receiver layer can be provided in a substantially uniform manner, for example it can be provided substantially in the same quantity on the surface of the paper or foil. In an alternative embodiment of the invention, the ink receiver layer can be provided accorded to a pattern, said pattern can preferably be in register with the pattern of the first and/or of the second printed pattern, preferably with a digital pattern provided upon the ink receiver layer itself. In this way it may be possible to reduce the quantity of inkjet receiving substance forming the ink receiver layer thereby limiting the cost of the décor paper. Thanks to this solution it may also be possible to limit increase of dot gain in the area printed with the second printed motif.

The ink receiver layer may comprise at least a binder. According to the most preferred embodiment, for the binder in said ink receiver layer at least or mainly polyvinyl alcohols are used.

According to variants, the ink receiver layer includes, as a binder, a polymer selected from the group consisting of hydroxyethyl cellulose; hydroxypropyl cellulose; hydroxyethylmethyl cellulose; hydroxypropyl methyl cellulose; hydroxybutylmethyl cellulose; methyl cellulose; sodium carboxymethyl cellulose; sodium carboxymethylhydroxethyl cellulose; water soluble ethylhydroxyethyl cellulose; cellulose sulfate; polyvinylalcohol, vinylalcohol copolymers; polyvinyl acetate; polyvinyl acetal; polyvinyl pyrrolidone; polyacrylamide; acrylamide/acrylic acid copolymer; polystyrene, styrene copolymers; acrylic or methacrylic polymers; styrene/acrylic copolymers; ethylene-vinylacetate copolymer; vinyl-methyl ether/maleic acid copolymer; poly(2-acrylamido-2-methyl propane sulfonic acid); poly(diethylene triamine-co-adipic acid); polyvinyl pyridine; polyvinyl imidazole; polyethylene imine epichlorohydrin modified; polyethylene imine ethoxylated; ether bond-containing polymers such as polyethylene oxide (PEO), polypropylene oxide (PPO), polyethylene glycol (PEG) and polyvinyl ether (PVE); polyurethane; melamine resins; gelatin; carrageenan; dextran; gum 9rabic; casein; pectin; albumin; chitins; chitosans; starch; collagen derivatives; collodion and agar-agar. The most preferred variants for the binder are polyvinyl alcohol, polyvinyl acetates, ethylvinylacetates, block copolymers based on polyvinylacetate, block copolymers based on polyvinylalcohol, acrylates, latexes, polyvinyl derivatives, VCVAC derivatives, polyurethanes based on polyols and isocyanates, polyurethanes based on polycarbamates and polyaldehydes, e.g. both as a watery dispersion/emulsion or a watery or solvent solution.

As stated above preferred binders for the ink receiver layer include polyvinyl alcohol (PVA), but according to variants a vinylalcohol copolymer or modified polyvinyl alcohol may be applied. The modified polyvinyl alcohol may be a cationic type polyvinyl alcohol, such as the cationic polyvinyl alcohol grades from Kuraray, such as POVAL C506, POVAL C118 from Nippon Goshei.

Preferably, said paper or foil is provided with 0.2 to 10 g/m², and preferably between 0.5 and 5 g/m², dry coating weight of a binder in said ink receiver layer.

Although not essential, according to the most preferred embodiment, the inkjet receiving layer comprises less than the 20%, preferably less than the 10% by weight of pigment or water absorbing, even more preferably substance is free from any pigment or water absorbing substance. Reducing the quantity of pigment or water absorbing substance can help improving the transparency of the ink receiver layer. Anyway, according to alternative embodiments, said ink receiver layer can comprise pigments, in this case at least or mainly silica particles are used. Preferably the silica particles are silane treated. Silane treatment of the pigments, in general, enhances dust release properties of the attained ink receiver layer and the thus treated paper or thermoplastic foil. The silane treatment may relate to a treatment with a coupling agent such as amino-organo-silanes, hydroxysilanes, dipodal silanes and/or other silanes. Preferably, the coupling agent is chosen such that the risk of yellowing upon aging of the attained ink receiver layer is low. Preferably, the coupling agent forms 0.1 to 10% of the total wet weight of the ink receiver layer.

According to variants, for the pigment of said ink receiver layer at least or mainly particles are used chosen from the list consisting of calcium carbonate, silica, alumina, aluminosilicates, ordered mesoporous materials, modified silica, organosilica, modified organosilica, organoalumina, modified alumina, aluminates, modified aluminates, organoaluminates, modified organoaluminates, zeolites, metal organic frameworks and porous polar polymers.

Preferably said pigment has a BET surface area between 10 and 1600 m²/g, and preferably between 15 and 500 m²/g.

It is to be noted that, the ink receiver coating can comprise also a crosslinking agent for the crosslinking reaction of the polymeric substance itself. In case of presence of a crosslinking agent this is preferably selected from the group comprising: aldehydes, polyaldehydes, dialdehydes, alcohols, boronic acid, borax, polyalcohols, carbamates, polycarbamates, carbonic acids, glyoxal based agent, zirconium-based agents, titanates and polycarbonic acids.

The ink receiver coating can further comprise a dispersant. A dispersant is an oligomer or polymer which stabilize the liquid dispersions of pigment against flocculation. The dispersant can comprise polycarboxylates, polyphosphates, a polyionic polymer, preferably polyDADMAC (Polydiallyldimethylammonium chloride) polyamine or alumina salts.

Preferably, the ink receiver coating is provided with less than 10%, more preferably less than 5% based on dry coating weight of dispersant, for example between 5 and 0.1%.

The ink receiver coating can also comprise a flocculant, preferably a metal salt, preferably a cationic metal salt. Preferably said metal salt is chosen from the list consisting of CaCl2, MgCl2, CaBr2, MgBr2, CMA (Calcium Magnesium Acetate), NH4Cl, Calcium Acetate, ZrCl4, calcium nitrate and Magnesium Acetate. The positive ion of the dissolved metal salt will tend to neutralize the electrosteric stabilization function of the pigment. The most preferred cationic metal salts are CaCl2, MgCl2, CMA, Calcium Acetate, calcium nitrate and Magnesium Acetate, as the inventors have obtained the best results with these ink reactive compounds. Said flocculant can also be chosen from the list consisting of sodiumaluminate, a double sulphate salt such as alum, polyaluminumchloride, polyacrylate, dicyandiamide (e.g. Floquat DI5 from SNF) and polyacrylamide. The flocculating agent pulls the ink pigments out of the ink dispersion. Thereby the pigments are prevented from penetration to far down into the ink receiver coating. Mainly the vehicle of the ink, e.g. the water in the case of waterbased inks, is absorbed deeper down into the ink receiver coating.

Preferably, ink receiver coating is provided with 20 to 70%, based on dry coating weight of flocculating agent, in particular of metal salt.

In a particular embodiment the ink receiver coating can be acidic. In particular can comprise one or more acid component. Said acid component can be either organic or inorganic. Preferred examples of acid component are citric acid, formic acid, lactic acid, propionic acid or a combination thereof. Preferably said acid component can show a pH 5, more preferably below 4.5. Said acid component has the function of destabilizing the ink dispersion and is generally used as an alternative to the above mentioned metal salts.

The inkjet receiver coating may also comprise one or more of the following agents:
Agents altering, more particularly lowering, the pH of said inkjet receiver coating. Preferably the pH of the inkjet receiver coating composition is lowered to pH 5 or lower, by selecting the amount and type of said substance, which selection is within the ambit of the skilled man Preferably said substance is chosen from the list consisting of formic acid, tartaric acid, acetic acid, hydrochloric acid, citric acid, phosphoric acid, sulfuric acid, AlCl₃ and boronic acid. An adjusted, more particularly lowered pH, preferably to pH 5 or less, increases the chemical affinity of the inkjet receiver coating with the ink and will interfere with the electrosteric stabilization function on the pigment, such that the dispersion of the pigments in the ink will become destabilized quickly.
Particle surface modifying agents or coupling agents: between 0.05 and 5 g/m², preferably between 0.2 and 2 g/m², e.g. chosen from the non-limiting list consisting of amino silanes, ureido silanes, aldehyde silanes, tetraethylorthosilicate, siliazanes, organically modified silanes, organically modified siliazanes, chlorosilanes, organically modified chlorosilanes, bissilanes, organobissilanes, silsesquioxanes, polysilsesquioxnes, silane oligomers, organically modified silane oligomers, bissilane oligomers, organically modified bissilane oligomers, oligomeric silsesquioxanes, and oligomeric polysilsesquioxanes.
Additives: wetting agent between 0.05 and 0.5 g/m²; and/or defoaming agent between 0.05 and 0.5 g/m²; and/or fungicide between 0.05 and 0.5 g/m².

According to the most preferred embodiment said ink receiver layer is applied in one step in order to form a unique layer having the ink receiver layer. Anyway, it is not excluded that said ink receiver layer is applied in at least two partial steps, wherein respectively a first layer with a first composition and, subsequently, a second layer is applied with a second composition wherein said first and second composition may be either the same or different compositions.

Preferably the starting paper layer or thermoplastic foil has a base weight of 40 to 130 grams per square meter, e.g. between 60 and 90 grams per square meter.

Preferably, in the case of a paper layer, the paper obtained using the method of the invention, i.e. including the inkjet receiver coating and of the printed motifs, has a Gurley value of between 10 and 60 seconds, and preferably between 12 and 50 seconds. Preferably, the paper layer can show, after performing the method, an increase of the Gurley value of less than 30% more preferably less than 20% based on the initial Gurley value of the starting paper layer. It is to be noted that the above indicated Gurley value of the printed paper layer is definitely lower than other coated paper layer, such a low Gurley value improves the resin impregnation capability of the paper layer, so that said paper layer are particularly suitable in use for décoration of panels, like for furniture or floor, wall of ceiling panels where the decorative paper is impregnated with melamine resin before lamination onto a supporting board. The obtained décor paper shows a resin penetration time lower than 3 sec.

In an alternative embodiment of the invention, instead of a paper layer, a thermoplastic foil, such as polyvinylchloride (PVC) foil, polypropylene (PP) foil, polyethylene (PE) foil, polyethylene-terephthalate (PET) foil or thermoplastic polyurethane (TPU) foil can be used. In case of presence of binder, the preferred binder for use on such thermoplastic foils is polyurethane based, acrylate based, or polyvinyl acetate based.

In the preferred example the décor paper is manufactured in a so-called roll to roll process, wherein the paper or foil is uncoiled from a first roll, printed, and then wound up again on a second roll. Preferably said paper or foil is provided with the first printed motif, the second printed motif and the ink receiver layer before being wound up on the second roll. In an alternative embodiment, after printing the paper or foil is cut into sheets that are ready to be laminated onto a board.

It is clear that the present invention also relates to décor papers or foils that are obtained using the methods of the first aspect of the present invention. With the same aim as in said first aspect, according to a second independent aspect, the invention also relates to a décor paper or foil comprising on one of its surfaces a first printed motif and a second printed motif above said first printed motif with the characteristic that the paper or foil comprises an ink receiving layer. It is to be noted that said paper or foil can comprise one or more of the features described above in relation to the first independent aspect.

The invention further, in accordance with its third independent aspect, relates to a method for manufacturing a laminate panel, wherein said panel at least comprises a substrate material and a provided thereon top layer with a printed décor, wherein said top layer comprises a décor paper or foil on the basis of a décor paper or foil in accordance with the second independent aspect and/or obtained by means of a method in accordance with the first independent aspect and/or the preferred embodiments of these aspects.

In the preferred embodiment the top layer is substantially formed from thermosetting resin and one or more paper layers, wherein said paper layers comprise the décor paper.

Alternatively said top layer can be substantially formed from thermoplastic material including one or more thermoplastic foils, wherein said thermoplastic foils comprise the décor foil.

In the preferred embodiment the décor paper can be impregnated with an amount of said thermosetting resin and is attached to said substrate material by means of a hot-pressing treatment. Alternatively, the décor foil can be attached to said substrate material by means of a hot-pressing treatment.

In the preferred embodiment said décor paper slayer is provided with an amount of thermosetting resin equaling 40 to 250% dry weight of resin as compared to weight of the paper. Experiments have shown that this range of applied resin provides for a sufficient impregnation of the paper, that avoids splitting to a large extent, and that stabilizes the dimension of the paper to a high degree.

Preferably the décor paper can be provided with such an amount of thermosetting resin, that at least the paper core is satisfied with the resin. Such satisfaction can be reached when an amount of resin is provided that corresponds to at least 1.5 or at least 2 times the paper weight. It should be clear that the resin, which is provided on the décor paper, is not necessarily only available in the core of the paper, but may form surface layers on both flat sides of the paper. The inkjet receiver coating may then be present on the surface of the paper with the intermediary of such a surface layer of thermosetting resin.

Preferably, the obtained resin provided paper layer, i.e. after provision of the thermosetting resin, has a relative humidity lower than 15%, and still better of 10% by weight or lower.

Preferably the step of providing said paper layer with thermosetting resin involves applying a mixture of water and the resin on said décor paper. The application of said mixture might involve immersion of the décor paper in a bath of said mixture and/or spraying, jetting or otherwise coating said mixture on said décor paper. Preferably the resin is provided in a dosed manner, for example by using one or more squeezing rollers and/or doctor blades to set the amount of resin added to the décor paper.

Preferably said thermosetting resin is a melamine-based resin, more particularly a melamine formaldehyde resin with a formaldehyde to melamine ratio of 1.4 to 2. Such melamine-based resin is a resin that polycondensates while exposed to heat in a pressing operation. Other examples of such thermosetting resins leading to a similar polycondensation reaction include ureum-formaldehyde based resins and phenol-formaldehyde based resins. It is not excluded that other resins like water-based polyurethane dispersions or water-based acrylic dispersions are being used or mixed combination thereof

As is clear from the above, the method of the fourth aspect of the invention preferably comprises the step of hot pressing the printed and resin provided décor paper, at least to cure the resin of the obtained resin provided décor paper. Preferably the method of the invention forms part of a DPL process as above described, wherein the printed resin provided décor paper of the invention is taken up in the stack to be pressed as the decorative layer. It is of course not excluded that the method of the invention would form part of a CPL (Compact Laminate) or an HPL (High Pressure Laminate) process in which the decorative layer is hot pressed at least with a plurality of resin impregnated core paper layers, e.g. of so called Kraft paper, forming a substrate underneath the decorative layer, and wherein the obtained pressed and cured laminate layer, or laminate board is, in the case of an HPL, glued to a further substrate, such as to a particle board or an MDF or HDF board.

Preferably a wear layer, for example a resin layer is applied above the décor paper, e.g. by way of an overlay, i.e. a resin provided carrier layer, or a liquid coating, preferably while the décor paper is laying on the substrate, either loosely or already connected or adhered thereto.

In case of décor thermoplastic foil, the wear layer can preferably be a transparent thermoplastic foil or in form of a lacquer layer or in form a TPU layer. The wear layer can be formed by a curable substance, like in case of lacquer, for example UV curable, electron beam curable or acid curable lacquer.

Preferably, the method of the third aspect of the invention further comprises the step of applying a counter layer or balancing layer at the surface of the substrate opposite the printed paper layer. In case of a paper-based décor layer, the counter layer or balancing layer preferably comprises a paper layer and thermosetting resin, preferably the same resin as the top layer. Preferably the mutual adherence of the plate-shaped substrate, the possible counter layer and the possible transparent or translucent layer is obtained in one and the same press treatment. According to the most preferred embodiment of the fourth aspect, these steps are taken up in a DPL process.

It is further clear that the décor paper, respectively décor foil, paper or thermoplastic foil obtained in the first aspect of the invention and/or according to the second aspect of the invention is suitable for being used as part of a top layer in a method for manufacturing floor panels, furniture panels, ceiling panels and/or wall panels.

It is clear that the printed pattern, the plate-shaped substrates, the paper layers and thermoplastic layers mentioned above may have to be divided during the methods of the invention for obtaining their respective final dimensions. The panels obtained by means of a DPL press treatment or similar are preferably sawn or otherwise divided. Other treatments of the obtained panels are of course not excluded.

The method according to the third independent aspect can further comprise the step of providing the panel, preferably the substrate thereof, with coupling elements.

A fourth independent aspect of the invention relates to a panel, preferably a floor, wall or ceiling panel, obtained by the method according to the third aspect and/or having a substrate and a top layer wherein the top layer comprises a décor paper or foil according the second independent aspect.

It is also to be noted that the fact that one between the first and the second printing method is configured to print at least one between a white, pearlescent, metallic or functional ink, forms an inventive concept irrespective from the presence of the ink receiver layer. Thereto according to its fifth independent aspect, the invention may relates to a method for manufacturing a décor paper or foil comprising the steps of providing a paper layer or a foil, providing said paper layer or foil with a first printed motif, wherein said first printed motif is provided by means of a first printing technique, providing a second printed motif above said first printed motif, wherein said second printed motif is provided by means of a second printing technique, wherein said second printing technique is different from said first printing technique, and wherein at least one between said first and second printed pattern is provided with at least one between a white, pearlescent, metallic or functional ink. Thanks to this solution, it is possible to combine printed patterns with functional or specific aesthetical effects which are not printable with all the printing techniques, with higher resolution or more variable printed pattern which are obtainable with other printing techniques.

The method according to the fourth independent aspect can comprise one or more of the features described in relation to the first independent aspect.

### BRIEF DESCRIPTION OF THE DRAWINGS

With the intention of better showing the characteristics of the invention, in the following, as an example without any limitative character, several preferred forms of embodiments are described with reference to the accompanying drawings, wherein:

FIG. 1 shows in perspective a panel according to the invention;

FIG. 2 shows a section view according to the line II-II indicated on FIG. 1;

FIG. 3 on a larger scale provide a view on the area F3 illustrated in FIG. 2;

FIG. 4 shows some steps in a method for forming the panel of FIG. 1;

FIG. 5 shows some steps in an alternative method for forming the panel of FIG. 1.

### DESCRIPTION OF NON-LIMITING EMBODIMENTS

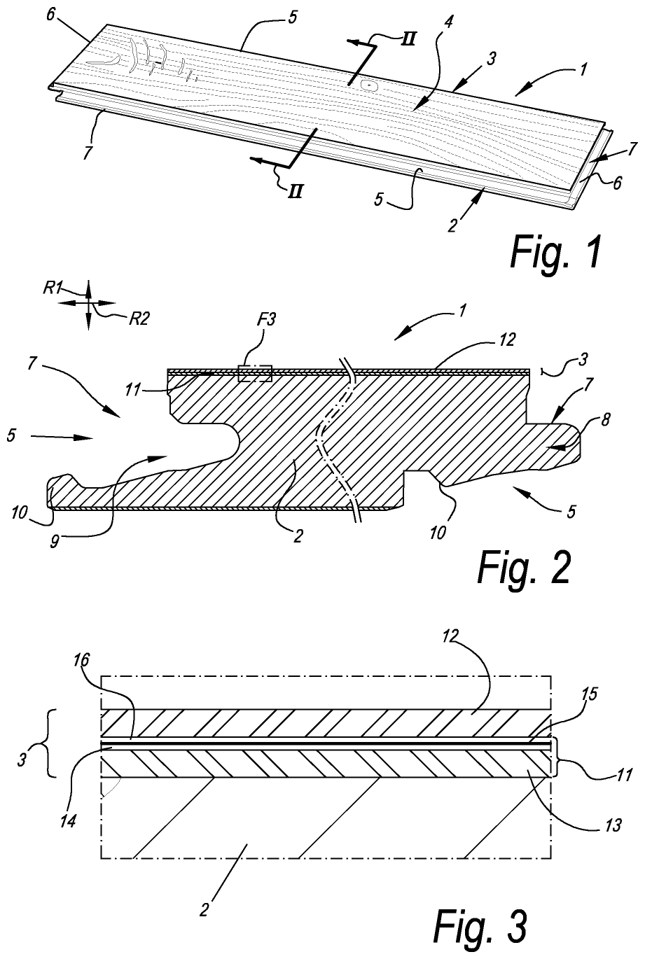

FIGS. 1 and 2 illustrate a decorative panel 1 comprising a substrate 2 made of a wood-based material, preferably MDF or HDF and a top layer 3 provided with a décor pattern 4, in this case imitating a wood décor. The panel 1 can have the shape of a rectangular and oblong floor panel, with a pair of long sides 5 and a pair of short sides 6. In this case the panel 1 is provided at least at the long sides 5 with coupling means 7 allowing to lock the respective sides 5 together with the sides of a similar panel both in a direction R1 perpendicular to the plane of the coupled panels, as in a direction R2 perpendicular to the coupled sides and in the plane of the coupled panels. As illustrated in FIG. 2 such coupling means or coupling parts can basically have the shape of a tongue 8 and a groove 9, provided with additional cooperating locking means 10 allowing for said locking in the direction R2.

FIGS. 2 and 3 shows that the top layer 3 comprises décor paper 11 and a wear layer 12 provided on top of the décor paper 11. In the example, the wear layer 12 preferably comprises a transparent sheet of paper impregnated with resin, preferably melamine The décor paper 11 comprises a paper layer 13 for example a décor base paper, and a first printed motif 14 provided directly on the paper layer 13. The first printed motif 14 and is an analog printed motif and it preferably comprise a uniform color, for example grey. In the example, the first printed motif 14 comprises an average color variation (ΔE) on the surface of the paper that is below 1, preferably below 0.5.

The décor paper 11 further comprises an ink receiver layer 15 provided on top of said first printed motif 14. In the example the ink receiver layer 15 comprises a binder and is free from any water absorbing substance or pigment. The binder preferably comprises polyvinyl alcohol. The ink receiver layer 15 further comprise a cross linker, a metal salt and other additives like dispersant, coupling agent, wetting agent or pH modifiers. The ink receiver layer 15 is transparent so that the first printed motif 14 is visible on the top layer 3 of the panel 1 and forms part of the décor pattern 4. The combination of the first printed motif 14 and the ink receiver layer 15 there upon has a color variation (ΔE) with a maximum value of 2, preferably with a maximum value of 1, even more preferably with a maximum value of 0.5. In fact, the ink receiver layer 15 is sufficiently transparent to cause a difference of color variation (CIELab) of the first printed motif 14 below, measured on the same spot between before and after providing said ink receiver layer 15 that is lower than the 20%, preferably lower than the 15%.

The décor paper further comprises a second printed motif 16, that in the example is a digitally printed motif imitating a wood nerve pattern. The second printed motif 16 is provided on the ink receiver layer 15. The second printed motif 16 and the first printed motif 14 together form the décor pattern 4. The décor paper 11 printed with the second printed motif 16 shows average color variation (ΔE) on the surface of the paper that is above 0.5, preferably above 1.

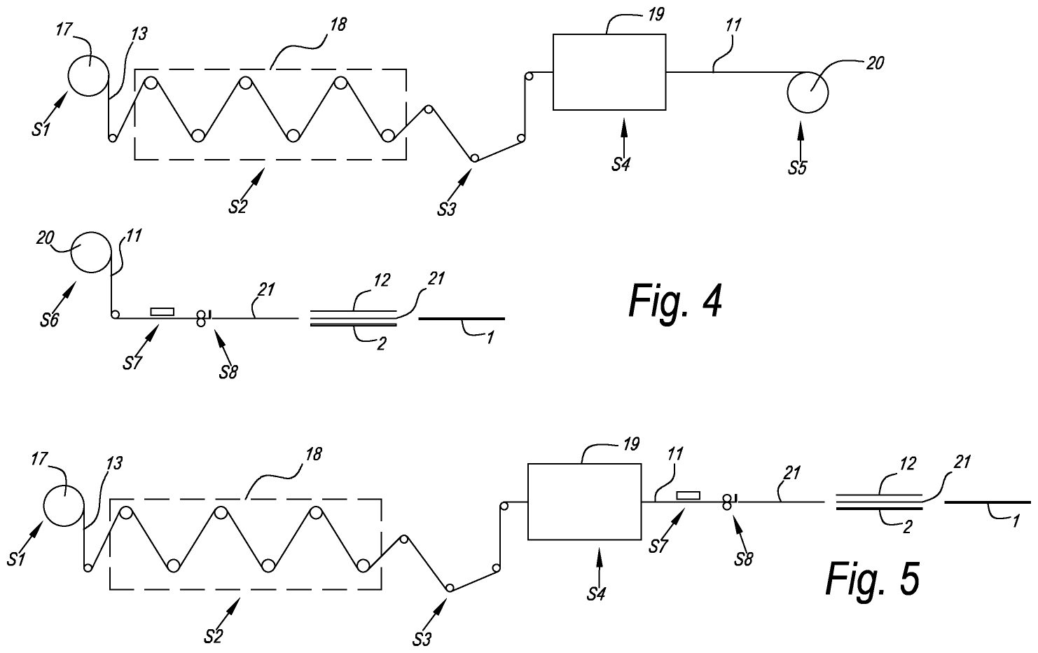

FIG. 4 shows some step of a method for manufacturing the panel 1. In the method is illustrated a step S1 of providing the paper layer 13 by uncoiling it from a first roll 17. The foil 13 is then provided, on at least a top surface, with the first printed motif 14 in a first printing step S2 that involves an analogue printing technique, for example rotogravure printing via a rotogravure printer 18.

The paper layer 13 provided with the first printed motif 14 is then provided, on at least its top surface, with the inkjet receiving layer 15, for example with a rotogravure printing unit, offset printing or doctor blade or a sprayer, in a step S3.

The paper layer 13 is then provided with the second printed motif 16 in a second printing step S4. Said second printing step S4 is preferably a digital printing operation and is performed by means of a single pass printer 19 using water-based ink comprising pigments. Preferably, in this said second printing step S4 the paper is provided with an amount of dry pigment that is lower to 10 g/sqm.

After printing, the obtained décor paper 11 is coiled again in a second roll 20 and then stocked, as indicated in step S5.

For the production of the panel 1, the décor paper 11 can be uncoiled from the second roll 20 in a step S6 and then impregnated with a resin, preferably melamine resin, in an impregnation step S7. The décor paper 11 can then be cut into sheets 21, in a cutting step S8. The sheet 21 of décor paper 11 is then sandwiched between the support 2 and the wear layer 12 and then laminated to form the panel 1 under action of heat and pressure.

In FIG. 5 it is shown an alternative method that differs from that of FIG. 4 in that after the second printing step S4 the decorative foil 11 is immediately impregnated with the resin in the impregnation step S7, then cut S8 into sheets 21 which are laminated onto between substrates 2 and wear layers 12 to form panels 1.

The present invention is in no way limited to the hereinabove described embodiments, but may be realized according to different variants without leaving the scope of the present invention.

Further, as is clear from the content of the description, the present invention relates to one or more of the items as listed below, numbered from 1 to 78:
1.—A method for manufacturing a décor paper or foil (11) comprising the steps of providing a paper layer or a foil (S1), providing said paper layer or foil (13) with a first printed motif (14), wherein said first printed motif (14) is provided by means of a first printing technique (S2), providing a second printed motif (16) above said first printed motif (14), wherein said second printed motif (16) is provided by means of a second printing technique (S4), wherein the method comprises the step of providing said paper layer or foil (13) with an ink receiver layer (15).
2.—The method according to item 1, wherein said ink receiver layer (15) is provided between the first printed motif (14) and the second printed motif (16).
3.—The method according to item 2, wherein said ink receiver layer (15) is transparent and/or translucent.
4.—The method according to item 3, wherein in case the ink receiver layer (15) is provided upon at least one between the first printed motif (14) and the second printed motif (16), it causes a difference of color variation (ΔE) of the printed motif (14, 16) below, measured between before and after providing said ink receiver layer (16) that is lower than 2, preferably lower than 1, even more preferably lower than 0.5 on the same spot.
5.—The method according to any of the preceding items, wherein the ink receiver layer comprises a binder and an ink destabilizing agent, preferably a metal salt.
6.—The method according to any of the preceding items, wherein the ink receiver layer is free from any pigment or water absorbing substance.
7.—The method according to any of the items from 1 to 5, wherein the ink receiver layer comprises a pigment, preferably silica.
8.—The method according to any of the preceding items, wherein said ink receiver layer (15) is provided according to a predetermined pattern.
9.—The method according to item 8, wherein said predetermined pattern is in register with the first printed motif (14) and/or with the second printed motif (16).
10.—The method according to any of the preceding items, wherein the second printing technique (S4) is different from the first printing technique (S2).
11.—The method according to any of the preceding items, wherein one of said printing techniques is an analog printing technique, preferably rotogravure, screen or flexographic printing.
12.—The method according to any of the preceding items, wherein said first printed motif (14) is a solid color motif, preferably grey, white yellow, brown or beige.
13.—The method according to anyone of items from 1 to 12, wherein said first printed motif (14) is a wood or stone imitating pattern.
14.—The method according to any of the preceding items, wherein at least one between said first printed motif (14) and said second printed motif (16) comprises metallic, pearlescent, and/or white pigments.
15.—The method according to any of the preceding items, wherein at least one between said first printed motif (14) and said second printed motif (16) comprises a homogeneous distribution of pigment over the entire paper layer.
16.—The method according to any of the preceding items, wherein in that at least said first printed motif (14) comprises an average color variation (ΔE) that is below 1, preferably below 0.5.
17.—The method according to item 16, wherein décor paper or foil provided with the first printed motif and with the ink receiver layer shows an average color variation (ΔE) on the surface of the paper that is below 1, preferably below 0.5.
18.—The method according to item 3, wherein in case the ink receiver layer (15) is provided upon at least one between the first printed motif (14) and the second printed motif (16), it causes a difference of color variation (ΔE) of the printed motif (14, 16) below, measured between before and after providing said ink receiver layer (16) that is lower than 20% preferably lower than 15% on the same spot.
19.—The method according to any of the preceding items, wherein said first printed motif (14) is obtained by printing at least a first ink that penetrates the paper layer (13) or foil such that the paper or foil is fully colored by said ink.
20.—The method according to item 19, wherein said first ink comprises a dye and/or a pigment and a wetting agent.
21.—The method according to any of the preceding items, wherein said second printed motif (16) is a wood or stone imitating pattern.
22.—The method according to any of the preceding items, wherein said first printed motif (14) and said second printed motif (16) together form a decorative pattern (4) of the décor paper or foil (11).
23.—The method according to any of the preceding items, wherein at least one of said printing techniques is a digital printing technique.
24.—The method according to item 23, wherein said digital printing technique is inkjet printing, preferably single pass inkjet printing.
25.—The method according to item 23 or 24, wherein said digital printing technique is performed by printing at least a pigment containing water-based ink.
26.—The method according to any of the preceding items, wherein said second printed motif (16) is in register with the first printed motif (14).
27.—The method according to any of the preceding items, wherein said paper is décor base paper.
28.—The method according to any of the preceding items, wherein said starting paper layer or foil has a base weight of 40 to 130 grams per square meter, e.g. between 60 and grams per square meter.
29.—The method according to any of the preceding items, wherein the obtained décor paper has a Gurley value of between 10 and 60 seconds, and preferably between 12 and seconds.
30.—The method according to any of the preceding items, wherein the obtained décor paper (11) shows an increase of the Gurley value of less than 30% more preferably less than 20% based on the initial Gurley value of the starting paper layer (13).
31.—The method according to any of the preceding items, wherein the foil is a thermoplastic foil, preferably a PVC foil.
32.—The method according to any of the preceding items, wherein the first and the second printing technique are performed in line.
33.—The method according to any of the preceding items, wherein said ink receiver layer is provided in a coating step performed in line with at least one of said first and second printing technique.
34.—The method according to any of the preceding items, wherein said paper layer or foil is uncoiled from a first roll, provided with the first printed motif and/or the second printed motif and wound up again in a second roller.
35.—A décor paper or foil (11) comprising on one of its surfaces a first printed motif (14) and a second printed motif (16) above said first printed motif (14), wherein it comprises an ink receiver layer (15).
36.—The décor paper or foil (11) according to item 35, wherein said ink receiver layer (15) is provided between the first printed motif (14) and the second printed motif (16).
37.—The décor paper or foil (11) according to item 35 or 36, wherein said ink receiver layer (15) is transparent and/or translucent.
38.—The décor paper or foil (11) according to any items from 35 to 37, wherein the ink receiver layer comprises a binder and an ink destabilizing agent, preferably a metal salt.
39.—The décor paper or foil (11) according to any items from 35 to 38, wherein the ink receiver layer is free from any pigment or water absorbing substance.
40.—The décor paper or foil (11) according to any items from 35 to 38, wherein the ink receiver layer comprises a pigment, preferably silica.
41.—The décor paper or foil (11) according to any items from 35 to 40, wherein said ink receiver layer (15) is disposed according to a predetermined pattern.
42.—The décor paper or foil (11) according to any items from 35 to 41, wherein said predetermined pattern is in register with the first printed motif (14) and/or with the second printed motif (16).
43.—The décor paper or foil (11) according to any items from 35 to 42, wherein the first and the second printed motif are obtained via different printing techniques.
44.—The décor paper or foil (11) according to any items from 35 to 43, wherein one of said printed motifs is an analog printed motif, preferably rotogravure or flexography printed motif.
45.—The décor paper or foil (11) according to any items from 35 to 44, wherein said first printed motif (14) is a solid color motif, preferably grey, white yellow, brown or beige.
46.—The décor paper or foil (11) according to any items from 35 to 45, wherein at least one between said first printed motif (14) and said second printed motif is a wood or stone imitating pattern.
47.—The décor paper or foil (11) according to any items from 35 to 46, wherein at least one between said first printed motif (14) and said second printed motif (16) comprises metallic, pearlescent, and/or white pigments.
48.—The décor paper or foil (11) according to any items from 35 to 47, wherein at least one between said first printed motif (14) and said second printed motif (16) comprises a homogeneous distribution of pigment over the entire paper layer.
49.—The décor paper or foil (11) according to any items from 35 to 48, wherein the décor paper or foil provided with the first and second printed motif shows an average color variation (ΔE) on the surface of the paper that is above 0.5, preferably above 1
50.—The décor paper or foil (11) according to any items from 35 to 49, wherein said first printed motif (14) comprises a first ink that penetrates the paper layer (13) or foil such that the paper or foil is fully colored by said ink.
51.—The décor paper or foil (11) according to item 50, wherein said first ink comprises a dye and/or a pigment and a wetting agent.
52.—The décor paper or foil (11) according to any items from 35 to 51, comprising a decorative pattern (4) that is formed by said first printed motif (14) and said second printed motif (16) together.
53.—The décor paper or foil (11) according to any items from 35 to 52, wherein at least one of said printed motif is a digital printed motif.
54.—The décor paper or foil (11) according to any items from 35 to 53, wherein said second printed motif (16) is in register with the first printed motif (14).
55.—The décor paper (11) according to any items from 35 to 54, wherein said paper is décor base paper.
56.—The décor paper (11) according to any items from 35 to 57, wherein it shows a Gurley value of between 10 and 60 seconds, and preferably between 12 and 50 seconds.
57.—The décor foil (11) according to any items from 35 to 54, wherein the foil is a thermoplastic foil, preferably a PVC foil.
58.—A method for manufacturing a panel, preferably a floor, wall or ceiling panel, of the type comprising a support and a top layer wherein the top layer comprises a décor paper or foil according to any of the items from 35 to 57 or obtained with the method according to any items from 1 to 34, wherein the method comprises the step of providing said décor paper (11) and the step of laminating said décor paper on top of said substrate.
59.—The method according to item 58, wherein it comprises impregnating said décor paper (11) with a resin, preferably melamine, before said lamination step.
60.—The method according to item 58 or 59, wherein said lamination step is performed through of application of heat and/or pressure.
61.—The method according to any item from 58 to 60, wherein before said lamination step, said décor paper or foil is sandwiched between the support and a wear layer.
62.—The method according to item 61, wherein said wear layer comprises a sheet of paper impregnated with resin, preferably melamine, or a transparent thermoplastic sheet, preferably PVC.
63.—The method according to any item from 58 to 62, wherein said substrate is made of a wood-based material, preferably HDF or MDF, or of a thermoplastic material, preferably PVC.
64.—The method according to any item from 58 to 63, wherein said step of lamination provides for a laminated board and wherein the method comprises the steps of cutting said boards into multiple panels.
65.—The method according to any item from 58 to 64, wherein it comprises the step of providing said panel with coupling element, preferably by milling.
66.—The method according to any item from 58 to 65, wherein it comprises the steps of the method according to any item from 1 to 34.
67.—A panel obtained by the method according to any of the items from 58 to 66.
68.—A panel preferably a floor, wall or ceiling panel, of the type comprising a support and a top layer wherein the top layer comprises a décor paper or foil according to any of the items from 35 to 57 or obtained with the method according to any items from 1 to 34.
69.—The panel according to item 68, wherein the top layer comprises a wear layer for example a sheet of paper impregnated with resin, preferably melamine, or a transparent thermoplastic sheet, preferably PVC.
70.—The panel according to item 68 or 69, wherein said substrate is made of a wood-based material, preferably HDF or MDF, or of a thermoplastic material, preferably PVC.
71.—The panel according to any item from 68 to 70, wherein it comprises edges provided with coupling elements for coupling with coupling elements of adjacent panel.
72.—A method for manufacturing a décor paper or foil (11) comprising the steps of providing a paper layer or a foil (S1), providing said paper layer or foil (13) with a first printed motif (14), wherein said first printed motif (14) is provided by means of a first printing technique (S2), providing a second printed motif (16) above said first printed motif (14), wherein said second printed motif (16) is provided by means of a second printing technique (S4), wherein said second printing technique is different from said first printing technique, and wherein at least one between said first and second printed pattern is provided with at least one between a white, pearlescent, metallic or functional ink.
73.—The method according to item 72, wherein one between the first and the second printing technique is a digital printing technique for printing a digital printed pattern.
74.—The method according to item 73, wherein the paper or foil is provided with an ink receiver layer before being printed with the digital printing technique.
75.—The method according to any of the items from 72 to 74, that comprises one or more of the features described in items from 1 to 34.
76.—A method for manufacturing a décor paper or foil (11) comprising the steps of providing a paper layer or a foil (S1), providing said paper layer or foil (13) with a first printed motif (14), wherein said first printed motif (14) is provided by means of a first printing technique (S2), providing a second printed motif (16) above said first printed motif (14), wherein said second printed motif (16) is provided by means of a second printing technique (S4), wherein said second printing technique is different from the first printing technique, wherein at least one between the first and the second printing technique is a digital printing technique for printing a digital printed pattern and wherein the paper or foil is provided with an ink receiver layer before being printed with the digital printing technique.
77.—The method according to item 76, wherein the digital printing technique is the first printing technique.
78.—The method according to item 76 or 77, that comprises one or more of the features described in items from 1 to 34.

1. A method for manufacturing a décor paper or foil, the method comprising:
providing a paper layer or a foil;
providing the paper layer or the foil with a first printed motif, wherein the first printed motif is provided by a first printing technique;
providing a second printed motif above the first printed motif, wherein the second printed motif is provided by a second printing technique; and
providing the paper layer or the foil with an ink receiver layer.

2. The method according to claim 1, wherein the ink receiver layer is provided between the first printed motif and the second printed motif.

3. The method according to claim 2, wherein the ink receiver layer is transparent and/or translucent.

4. The method according to claim 3, wherein the ink receiver layer causes a difference of color variation of the first printed motif, measured before and after providing the ink receiver layer that is lower than 2 on the same spot.

5. The method according to claim 1, wherein the ink receiver layer comprises a binder and an ink destabilizing agent.

6. The method according to claim 1, wherein the ink receiver layer is free from any pigment or water absorbing substance.

7. The method according to claim 1, wherein the ink receiver layer comprises a pigment.

8. The method according to claim 1, wherein the ink receiver layer is provided according to a predetermined pattern.

9. The method according to claim 8, wherein the predetermined pattern is in register with the first printed motif and/or with the second printed motif.

10. The method according to claim 1, wherein the second printing technique is different from the first printing technique.

11. The method according to claim 1, wherein one of the printing techniques is an analog printing technique.

12. The method according to claim 1, wherein the first printed motif is a solid color motif.

13. The method according to claim 1, wherein the first printed motif is a wood or stone imitating pattern.

14. The method according to claim 1, wherein at least one of the first printed motif and the second printed motif comprises metallic, pearlescent, and/or white pigments.

15. The method according to claim 1, wherein at least one the first printed motif and the second printed motif comprises a homogeneous distribution of pigment over the entire paper layer.

16. The method according to claim 1, wherein in the first printed motif has an average color variation that is below 1.

17. The method according to claim 16, wherein the décor paper or foil provided with the first printed motif and with the ink receiver layer shows an average color variation on the surface of the paper that is below 1.

18. The method according to claim 3, wherein the ink receiver layer causes a difference of color variation of the first printed motif, measured before and after providing the ink receiver layer that is lower than 20% on the same spot.

19. The method according to claim 1, wherein the first printed motif is obtained by printing at least a first ink that penetrates the paper layer or the foil such that the paper layer or the foil is fully colored by the first ink.

20. The method according to claim 19, wherein the first ink comprises a dye and/or a pigment and a wetting agent.

21.-74. (canceled)
